(19) United States
(12) Patent Application Publication
(10) Pub. No.: US 2012/0279645 A1
(43) Pub. Date: Nov. 8, 2012

(54) DOUBLE-FACED ADHESIVE TAPE JOINING METHOD AND DOUBLE-FACED ADHESIVE TAPE JOINING APPARATUS

(76) Inventors: Shinji Inokuchi, Ibaraki-shi (JP); Kazuhiko Kinpara, Ibaraki-shi (JP); Naoto Kato, Ibaraki-shi (JP); Isao Hirose, Ibaraki-shi (JP)

(21) Appl. No.: 13/265,906

(22) PCT Filed: Apr. 20, 2010
(86) PCT No.: PCT/JP2010/002843

§ 371 Date: Oct. 24, 2011

(30) Foreign Application Priority Data
May 1, 2009 (JP) 2009-111962

(51) Int. Cl. B32B 37/12; B32B 38/04

(52) U.S. Cl. 156/250; 156/510

(57) ABSTRACT

A double-faced adhesive tape is accurately joined to a bent tape joining face of a workpiece while a separator on an upper surface remains without separation of the separator. Specifically, the double-faced adhesive tape has the separator on the upper surface remaining and a separator on a lower surface being separated, and a rotary cutter forms slits at given intervals along sides of the separator on the double-faced adhesive tape that is to be supplied to a tape joining position. Then, the double-faced adhesive tape having the separator with the slits formed therein is guided to the tape joining position at a front end of apparatus, and is successively joined to a front face of the workpiece while being pressed with a joining roller.

### TECHNICAL FIELD

This invention relates to a method and apparatus for joining a double-faced adhesive tape successively to a front face of a workpiece.

### BACKGROUND ART

The following method is known for joining an adhesive tape successively to a front face of a workpiece. For instance, an adhesive tape with a separator is guided to a hand-held joining device, and an adhesive face thereof is exposed while the separator is separated. Then, the apparatus is moved while the adhesive face is pressed against a given joining face. Accordingly, the adhesive tape is successively joined to the workpiece (see Patent Literature 1.)

[Patent Literature 1]

Japanese Patent Publication No. 2005-35724

### DISCLOSURE OF THE INVENTION

### Problem to be Solved by the Invention

It is also possible to join a double-faced adhesive tape with the same manner as above. However, the following problem may arise. That is, the double-faced adhesive tape is supplied with separators joined to both adhesive face of an adhesive tape body, and is joined to the workpiece while one separator is separated. Thereafter, in another process, the other separator is separated from a surface of the adhesive tape already joined to the workpiece, thereby an adhesive face is exposed. A desired member is to be joined under this state.

The separator remaining on the surface of the adhesive tape may possibly be separated and float inadvertently upon transportation of the workpiece having the adhesive tape joined thereto. Herein, the exposed adhesive face may possibly be degraded on exposure to air. Moreover, contamination may possibly adhere to an adhesive face, and adhesive performance thereof may be reduced. Consequently, the separator on the surface of the double-faced adhesive tape joined to the workpiece needs not to be separated and float up inadvertently.

When the double-faced adhesive tape is joined along a linear course or a loose curved course having approximately a straight line on the front face of the workpiece, the separator on the joined surface of the double-faced adhesive tape is not separated and floats up inadvertently. On the other hand, where the adhesive tape with a separator is joined on a curved course slightly bent or having a small curvature, a less elasticity of the separator than the body of the double-faced adhesive tape may cause “float” or wrinkles of the separator due to a restoring force of the separator.

Specifically, a material with smaller elasticity than an adhesive tape body, e.g., a resin tape of low adhesive property capable of ready separation from an adhesive face of an adhesive tape and a paper material to which resin coating is performed, is adopted for the separator. Accordingly, when the double-faced adhesive tape is joined on a course having a small curvature, the double-faced adhesive tape inside of a curved portion is joined while being compressed in a tape joining direction. On the other hand, the double-faced adhesive tape outside of the curved portion is joined while expanding in the tape joining direction. Herein, the separator inside of the curved portion where compression occurs has some wrinkles only, and is not separated greatly from the adhesive face. However, the separator outside of the curved portion where expansion occurs cannot follow expansion of the double-faced adhesive tape. Accordingly, the separator may readily be separated from the adhesive face. Moreover, separation outside of the curved portion expands toward a periphery thereof, and the separator is separated and floats up in a large range of the curved portion.

This invention has been made regarded to the state of the art noted above, and its primary object is to provide a method and apparatus of joining a double-faced adhesive tape that allows suitable joining of a double-faced adhesive tape even on a curved course without separating a separator.

### Means for Solving the Problem

This invention is configured as under to achieve the above object. This invention discloses a method of joining to a joining face of a workpiece a double-faced adhesive tape having one adhesive face exposed and the other adhesive face to which a separator is joined. The double-faced adhesive tape is successively joined to a front face of the workpiece while slits are formed at given intervals on sides of the separator joined to the supplied double-faced adhesive tape along a longitudinal tape direction.

According to this method, the slits are formed on the curved joining course at given intervals as to intersect the sides of the separator. The slits open outside of a curved portion where the double-faced adhesive tape expands. Consequently, there may be suppressed inadvertent separation and floating of the separator with poor elasticity from the adhesive tape body due to tension over a large range in a longitudinal tape direction.

This invention is characterized in that the slits are formed on both sides of the separator at given intervals along the longitudinal tape direction.

According to this method, when joining is performed along the serpentine joining course in a curved or bent manner, slits may be formed on the sides of the separator at any outside of the curved portion of the joining course. Consequently, there may be suitably controlled separation of the separator from any outside of the curved portion.

Moreover, this invention is characterized in that formation of the slits may be avoided on a linear joining course on the workpiece, and formation of the slits may be performed on a curved joining course.

According to this invention, when both the linear joining course and the curved or bent joining course exist, the slits may be formed only on the curved joining course where the separator may possibly be separated. Consequently, formation of unnecessary slits may be avoided on the linear joining course where no separation of the separator possibly occurs, which results in a simple joining operation.

This invention also discloses double-faced adhesive tape joining apparatus for joining to a joining face of a workpiece a double-faced adhesive tape having one adhesive face exposed and the other adhesive face to which a separator is joined. The apparatus includes a tape guide device, a joining section, and a tape cutting mechanism. The tape guide device guides the double-faced adhesive tape to a joining position that is successively supplied to a base. The joining section presses against the joining face of the workpiece the double-faced adhesive tape guided to the joining portion at a front end of the base. The tape cutting mechanism forms slits on sides of the separator at given intervals along a longitudinal tape direction.

With this configuration, the method of joining the double-faced adhesive tape may suitably be performed.

It is preferable that the tape cutting mechanism of this invention includes an arm and a rotary cutter. The arm is pivotally connected to the base and swingingly moves downward. The rotary cutter is provided at a lower portion of the arm for cutting the separator on the double-faced adhesive tape from an upper side.

According to this configuration, the double-faced adhesive tape travels while being interposed between the rotary cutter and a holding roller. Accordingly, slits may be formed successively on the sides of the separator accurately at given pitches.

It is preferable that the tape cutting mechanism of this invention may switch back and forth between an operating condition where a slit is formed and a non-operating condition where no slit is formed.

According to this configuration, when both the linear joining course and the curved or bent joining course exist, the slits may be formed only on the curved joining course where the separator may possibly be separated. Consequently, formation of unnecessary slits may be avoided on the linear joining course where no separation of the separator possibly occurs, which results in suitable implementation of this invention.

This invention preferably includes an elastic body for swingingly biasing the arm upward relative to the base.

This configuration may suitably implement this invention.

This configuration preferably includes a holding mechanism for fixedly holding the arm on the base such that the rotary cutter at the lower portion of the arm is fixed in an operation position when the arm moves downward against swinging bias.

According to this configuration, when the curved joining course is long, an operator may concentrate on an operation of following the long curved joining course without continuously applying a force. Consequently, smooth joining ma_{y}be conducted under constant pressure, which results in enhanced adhesion of the double-faced adhesive tape to the workpiece.

Moreover, the joining section of this configuration may be a roller supported on the front end of the base as to freely rotate. Alternatively, the joining section may be configured through formation of a tape joining groove at the planar front end of the base having a smaller thickness and a larger width than the double-faced adhesive tape.

### Effect of the Invention

As above, with the double-faced adhesive tape joining method and apparatus according to this invention, the double-faced adhesive tape may be accurately joined even on the curved or bent course with no separation of the separator.

### BRIEF DESCRIPTION OF THE DRAWINGS

FIG. 1 is a perspective view of double-faced adhesive tape joining apparatus.

FIG. 2 is an exploded perspective view of the double-faced adhesive tape joining apparatus.

FIG. 3 is a side view of the double-faced adhesive tape joining apparatus.

FIG. 4 is a plan view of the double-faced adhesive tape joining apparatus.

FIG. 5 is a vertical sectional side view showing a joining operation where no slit is formed in a separator.

FIG. 6 is a vertical sectional side view showing a joining operation where slits are formed in a separator.

FIG. 7 is a perspective view showing a joining operation.

FIG. 8 is an enlarged perspective view of tape slits.

FIG. 9 is a partial perspective view of a double-faced adhesive tape.

FIG. 10 is a perspective view showing double-faced adhesive tape joining apparatus according to another embodiment.

FIG. 11 is a side view showing a general configuration of the double-faced adhesive tape joining apparatus according to another embodiment.

FIG. 12 is a plan view showing a general configuration of the double-faced adhesive tape joining apparatus according to another embodiment.

FIGS. 13 and 14 are vertical sectional side views each showing a joining operation in another embodiment.

### DESCRIPTION OF REFERENCES

2 . . . base
5 . . . tape cutting mechanism
16 . . . rotary cutter
18 . . . holding roller
T . . . double-faced adhesive tape
k . . . slit
s1 . . . separator
s2 . . . separator
W . . . workpiece

### BEST MODE FOR CARRYING OUT THE INVENTION

One embodiment of this invention is now to be described below with reference to the drawings.

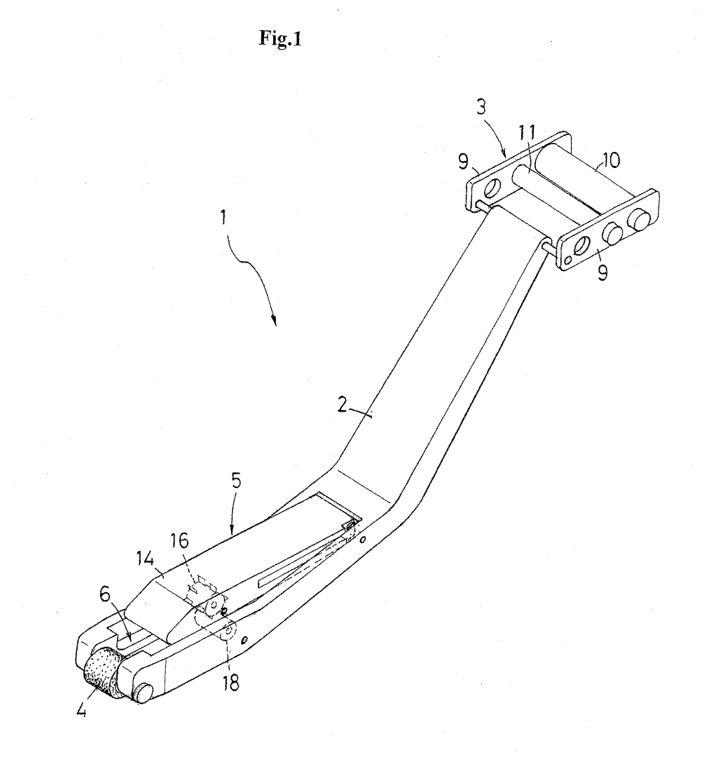

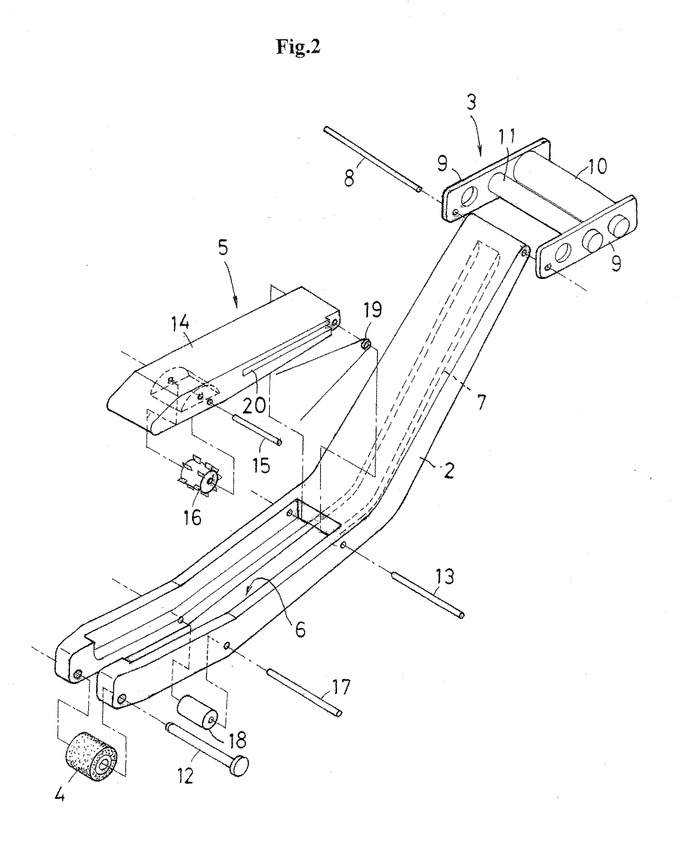

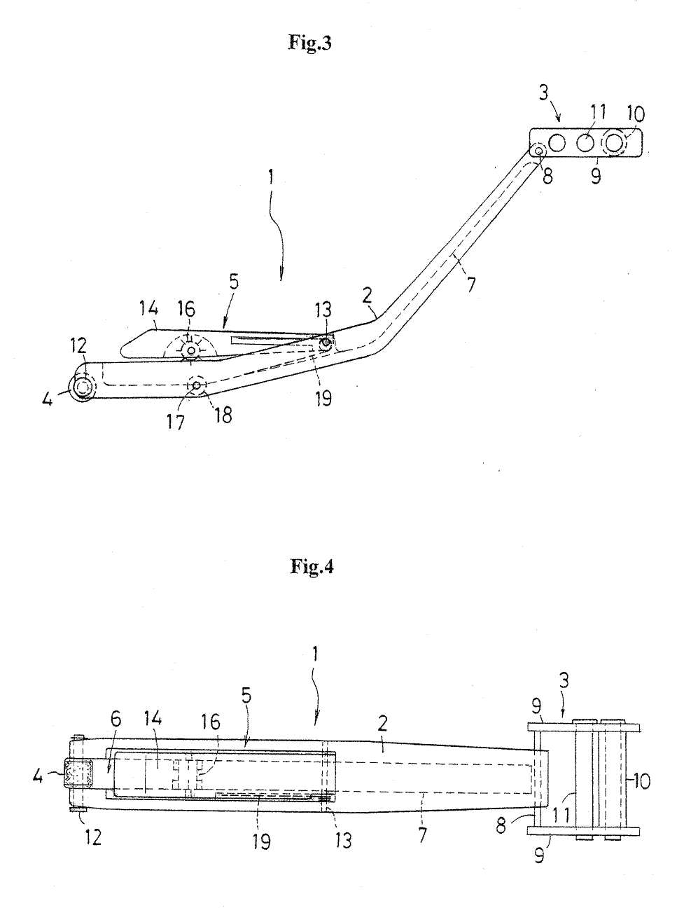

FIGS. 1 to 7 are each one example of double-faced adhesive tape joining apparatus according to this invention. FIG. 1 is a perspective view of a general configuration of the apparatus. FIG. 2 is an exploded perspective view thereof. FIG. 3 is a side view thereof. FIG. 4 is a plan view thereof

A double-faced adhesive tape T adopted in this embodiment is formed through joining and holding separators s1 and s2, respectively, onto upper and lower surfaces of an adhesive tape body t. The adhesive tape body t has adhesive layers tb on upper and lower surfaces of a base material to of a several millimeters width that is composed of a foamed resin material elastically deformable.

Such as a base material with a separation layer, a base material of a low adhesive property composed of fluorine-based polymer, a base material of a low adhesive property composed of non-polar polymer may be adopted for the separators s1, s2. For the base material with the separation layer, a plastic film or a paper material is for example adopted to which a release coating, such as a silicone release coating, a long-chain alkyl based release coating, a fluorine based release coating, and a molybdenum sulfide, is applied. Moreover, for the fluorine-based polymer, such as polytetrafluoroethylene, polychlorotrifluoroethylene, polyvinyl fluoride, polyvinylidene fluoride, a tetrafluoroethylene hexafluoropropylene copolymer, and a chlorofluoroethylene-vinylidene fluoride copolymer is adopted. Moreover, for the non-polar polymer, an olefin-based resin, such as polyethylene and polypropylene, is adopted.

The double-faced adhesive tape joining apparatus 1 is configured such that an operator may hold it for use with one hand. As shown in FIG. 1, the double-faced adhesive tape joining apparatus 1 is bent into an inverted L-shape, and includes a base 2 that allows holding with one hand, a tape guide 3 provided at a rear end of the base 2, a joining roller 4 as a joining section provided at a front end of the base 2, and a tape cutting mechanism 5 provided at a front half section of the base 2.

The base 2 is formed of a hard resin material having superior smoothness. As shown in FIGS. 2 to 4, the base 2 has an opening 6 at the front half section in an approximately horizontal attitude that is formed in a forward/backward direction as to open vertically and forwardly. The opening 6 has the tape cutting mechanism 5 incorporated therein. A tape guide groove 7 is formed in a forward/backward direction on a lower surface of a rear half section of the base 2 inclined obliquely upward toward the rear side, and one end of the tape guide groove 7 is communicated with the opening 6.

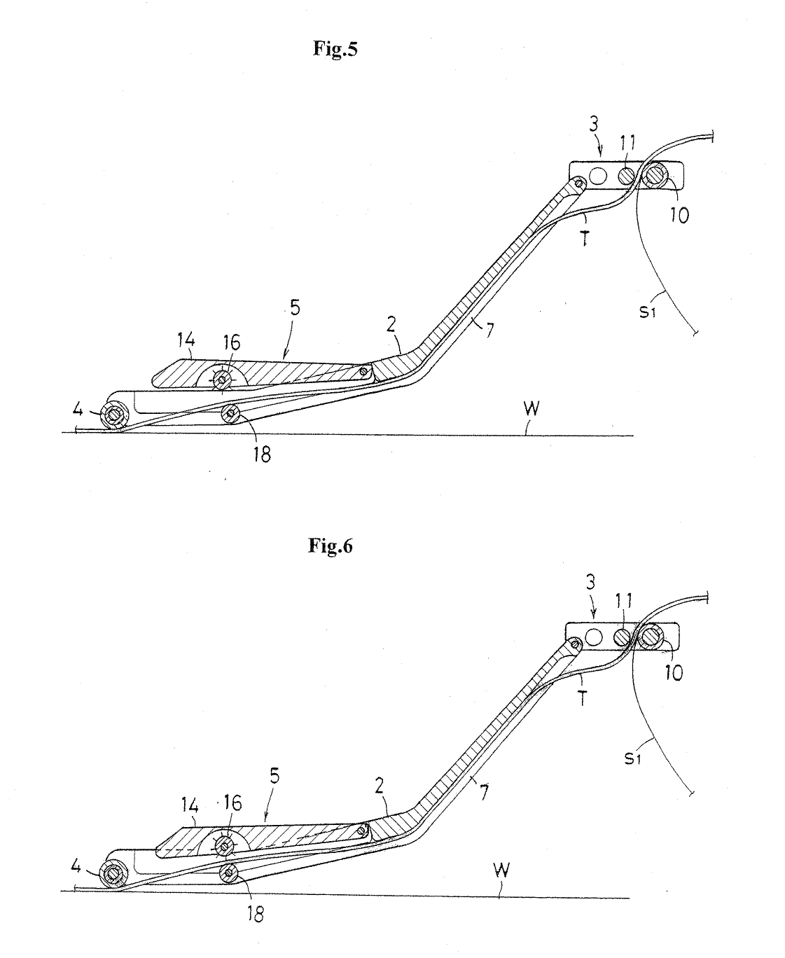

The tape guide 3 includes a pair of right and left brackets 9, a guide roller 10 and a guide pin 11 each supported across both brackets 9, the brackets being pivotally connected to the rear end of the base 2 via a support shaft 8 as to swing upward and downward. Moreover, as shown in FIGS. 5 to 7, the tape guide 3 guides the double-faced adhesive tape T with a separator that is fed out from a tape supply section, not shown, as to feed the tape T from upward between the guide roller 10 and the guide pin 11 and as to wind and guide the tape T downward. A separator s1 on the lower surface of the tape is to be separated in this winding region. The double-faced adhesive tape T has an exposed adhesive face directed downward through separation of the separator s1, and is guided via the tape guide groove 7 to a lower portion of the base 2, and is supplied under the joining roller 4. The tape guide 3 corresponds to the tape guide device in this invention.

The joining roller 4 is formed of an elastic body having a larger width than the double-faced adhesive tape T. The joining roller 4 is pivotally supported horizontally via a support shaft 12 at the front end of the base 2 as to freely rotate.

The tape cutting mechanism 5 includes an operation arm 14, a rotary cutter 16, and a holding roller 18. The operation arm 14 is pivotally connected adjacent to the rear end of the opening 6 via a support shaft 13 as to swing upward and downward. The rotary cutter 16 is pivotally supported on a support shaft 15 on a lower portion in the middle of the operation arm 14 as to freely rotate. The holding roller 18 is pivotally supported on the base 2 via a support shaft 17 as to freely rotate. Here, the operation arm 14 corresponds to the arm in this invention.

The support shaft 13 is inserted into a torsion spring 19 from outside. One end of the torsion spring 19 is fitted into a groove 20 formed in a side surface of the operation arm 14, and the other end fitted into a step formed inside of the opening 6. An elastic restoring force of the torsion spring 19 biases the operation arm 14 to swing upward. Here, after one end of the torsion spring 19 is fitted into the groove 20, a resin or a block is enclosed in the groove 20 for preventing the torsion spring 19 from being detached.

As shown in FIG. 8, the rotary cutter 16 has two or more cutter blades 16b embedded radially in a circumference direction at equal pitches on opposite ends of a resin roller 16a along the support shaft 15. The rotary cutter 16 is held apart upward from the holding roller 18 in a non-operation position under a free state where no external force pressing downward is applied to the operation arm 14. Moreover, when an external force pressing downward is applied to the operation arm 14, the operation arm 14 swings downward, whereby the rotary cutter 16 moves into a tape cutting position adjacent to the holding roller 18. Here, the rotary cutter 16 is set to have a width larger than the double-faced adhesive tape T.

The holding roller 18 holds and guides the double-faced adhesive tape T that is guided under the base 2. The holding roller 18 is formed of an adhesion-resistant resin roller for smoothly guiding and traveling the double-faced adhesive tape T having an adhesive face directed downward from which the separator s1 is separated. The holding roller 18 also serves as a holder of the rotary cutter 16. Accordingly, a position of the holding roller 18 is set as to face to the rotary cutter 16 from downward.

The double-faced adhesive tape joining apparatus 1 according to this invention is configured as described above. Next, description will be given of a joining operation with use of the double-faced adhesive tape joining apparatus 1.

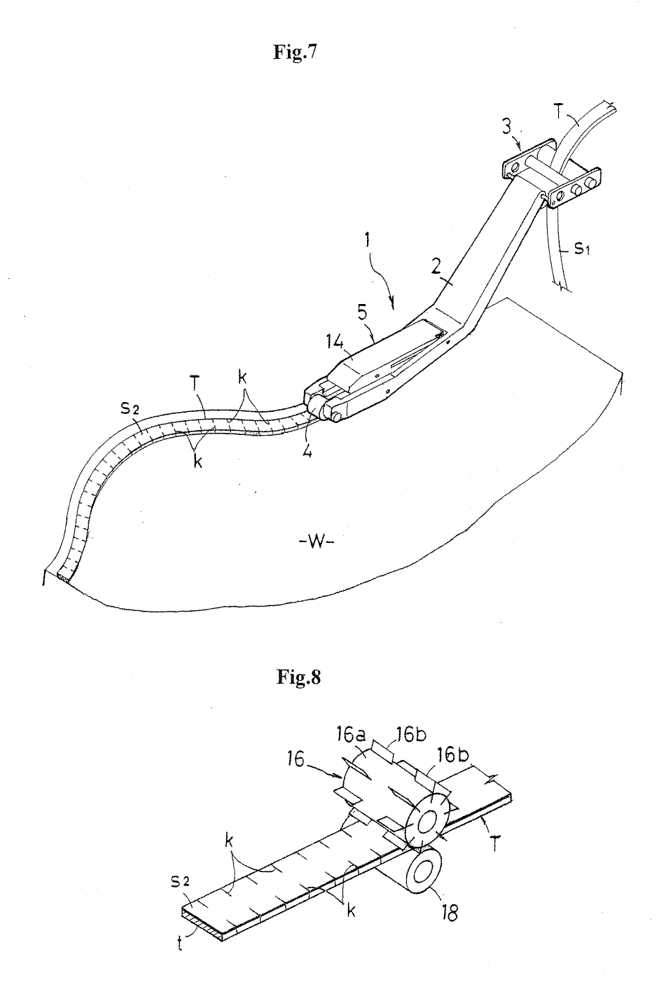

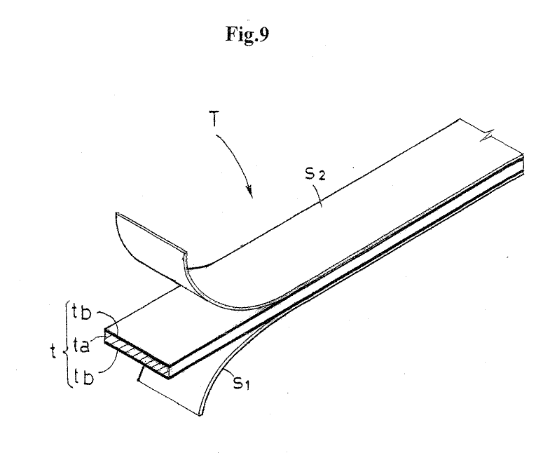

The front end of the double-faced adhesive tape T having an exposed adhesive face directed downward is joined to a joining start position in the joining face of a workpiece W. Thereafter, as shown in FIG. 7, the double-faced adhesive tape joining apparatus 1 held with one hand is moved backward relative to the workpiece W. Here, the double-faced adhesive tape T is joined along a given joining course while being pressed with the joining roller 4 as an attitude of the double-faced adhesive tape joining apparatus 1 varies laterally.

Herein, as shown in FIG. 5, the rotary cutter 16 is held in a non-operation position on an upper side on the linear joining course. Whereas, as shown in FIG. 6, the operation arm 14 is pressed with a finger of the hand holding the base 2 on the curved joining course for moving downward the rotary cutter 16 into the tape cutting position and sandwiching the double-faced adhesive tape T between the holding roller 18 and the rotary cutter 16. Such sandwiching causes the cutter blade 16b of the rotary cutter 16 to engage the double-faced adhesive tape T from upside, whereby slits k are formed at fixed pitches along the longitudinal tape direction as to intersect both sides of the double-faced adhesive tape T. Herein, only the separator s2 on the upper surface of the tape may be cut or slits k may be formed over the separator s2 and the adhesive tape body t depending on pressure of the rotary cutter 16.

As above, slits k are formed at given pitches in the longitudinal tape direction on the sides of the separator s2 on the curved joining course, thereby opening approximately outside of the curved portion where the double-faced adhesive tape T expands. Such opening may prevent the separator s2 with poor elasticity from being separated from the adhesive tape body t due to tension to float over a long range in the longitudinal tape direction.

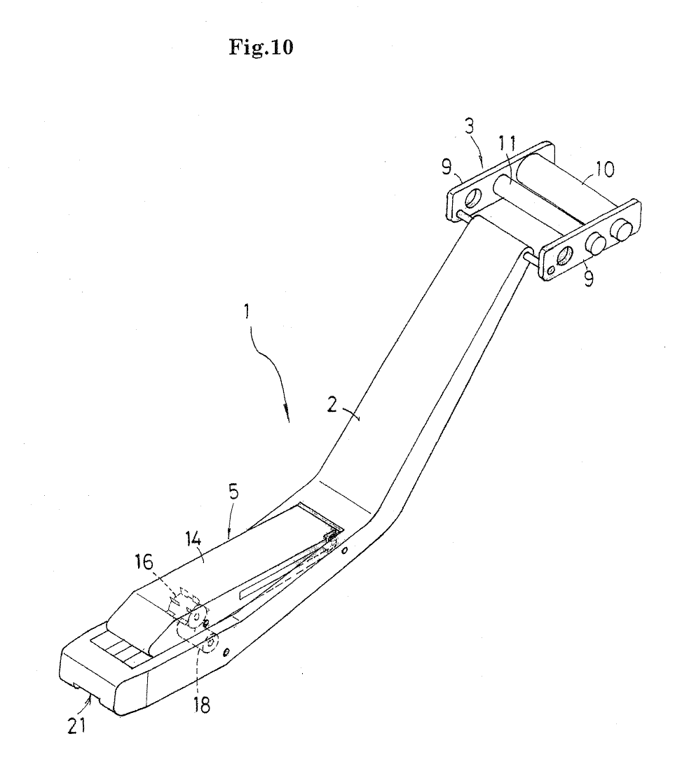

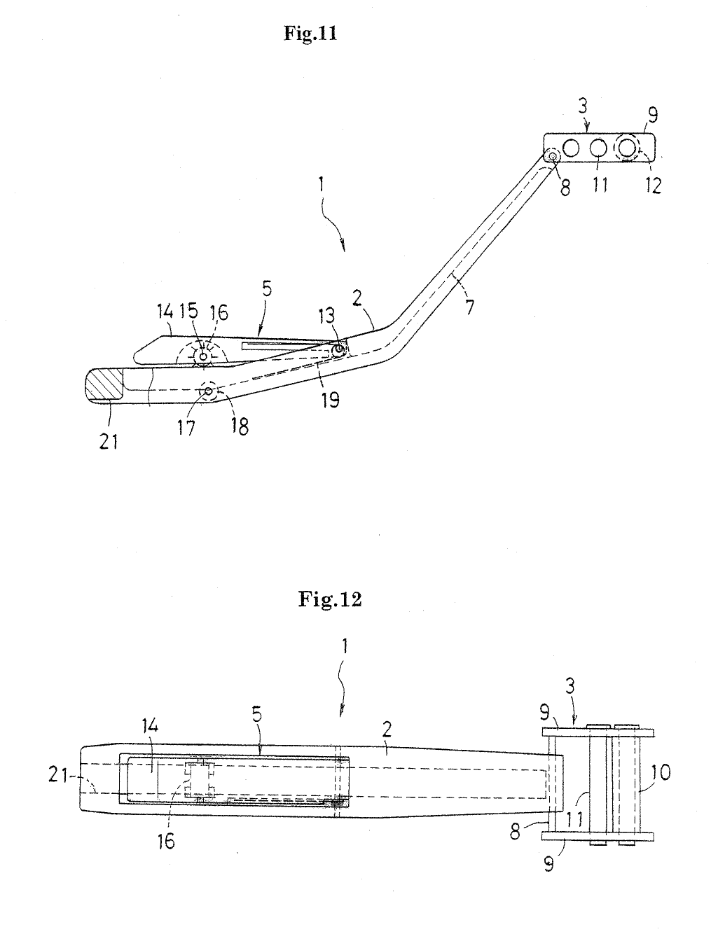

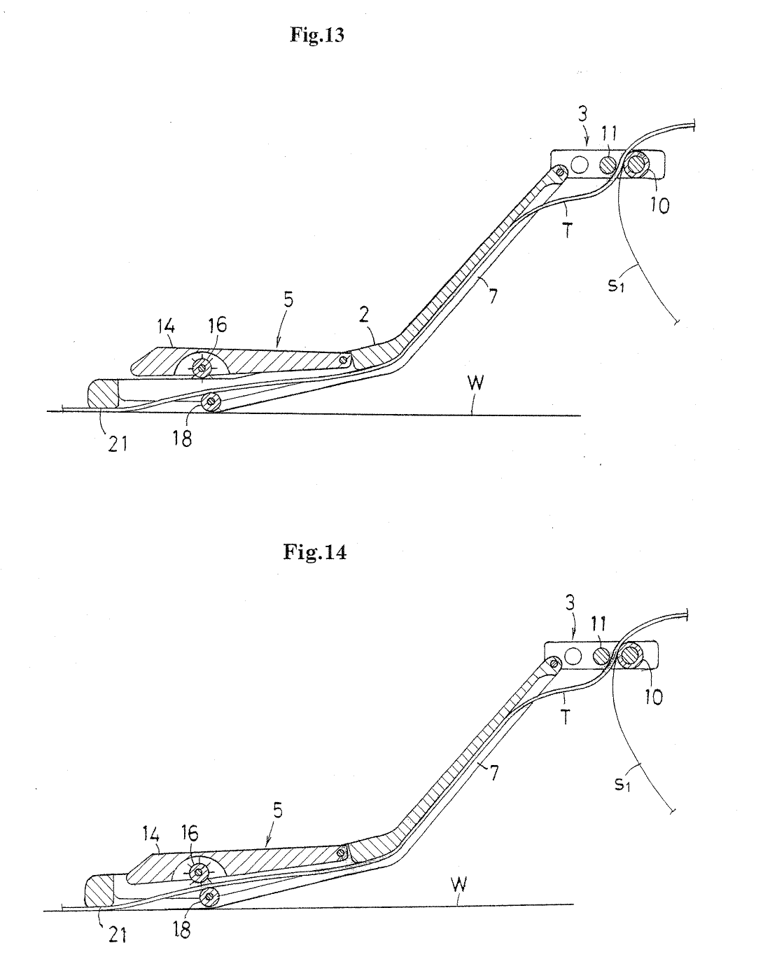

Next, FIGS. 10 to 14 shows another embodiment of this invention.

This embodiment includes a joining section having the joining roller 4 omitted from the configuration of the above-mentioned embodiment. Specifically, a tape joining guide groove 21 is formed in a lower surface of the planar front end of the base 2 having a smaller thickness than the double-faced adhesive tape T.

The double-faced adhesive tape T is guided into the tape joining guide groove 21, which allows joining thereof to the front face of the workpiece W while pressing appropriately and being elastically deformed.

This invention may be embodied as the following aspects.

(1) The slits k on opposite ends of the double-faced adhesive tape T may be formed as under other than those in a linear shape.

For instance, the slits k may be formed to be cut alternately on both sides of the tape. Alternatively, a slit in a notch shape may be formed that is tapered from the side toward a center in the longitudinal direction. Herein, the rotary cutter 16 has cutter blades 16b in a V-shape embedded on both ends thereof

(2) In the foregoing embodiments, the slits k are formed on both sides of the double-faced adhesive tape T. Where joining is performed on the joining course curved or bent in one direction, slits k may be formed only on the tape side outside of the curved portion where the tape expands. In other words, the rotary cutter 16 may include cutter blades 16b formed on only one end thereof.

(3) In the foregoing embodiments, the rotary cutter 16 switches to a tape cutting position through continuous pressing of the operation arm 14 with the hand or finger. Alternatively, the operation arm 14 may be fixedly held with a detent mechanism appropriately in a lower swinging position.

For instance, such as a metal ball is biased that a front portion thereof projects from at least one side surface of the front end of the operation arm 14, and a recess facing and engaging the ball is formed in a position in a base body.

According to this configuration, when the curved joining course is long, an operator may concentrate on an operation of following the long curved joining course without continuously applying a force to the hand or finger. Consequently, smooth joining may be conducted under constant pressure, which results in enhanced adhesion of the double-faced adhesive tape T to the workpiece W. Here, the detent mechanism corresponds to the holding mechanism of this invention.

(4) In another embodiment mentioned above, the rotary cutter 16 forming the tape cutting mechanism may be provided above the tape joining guide groove 21 as to move upward and downward for formation of the slits k in the tape joining position.

(5) The double-faced adhesive tape T may be adopted that has separators s1, s2 on both faces of the adhesive tape body t composed of adhesive only.

(6) The foregoing embodiment discloses the case where the double-faced adhesive tape T having the separators s1 and s2 joined on both surfaces thereof is supplied and joined to the workpiece W while one separator s1 is separated and removed in the tape guide 3. Alternatively, such aspect may be embodied to supply the adhesive tape T from which one separator s1 is separated in advance during another process or the double-faced adhesive tape T in a roll- form having the separator s2 joined to one face thereof.

(7) The foregoing embodiments disclose performance of joining the tape manually through holding by an operator. Alternatively, joining of the tape may be performed automatically through attachment to a robot hand. In this case, an actuator may appropriately switch positions of the rotary cutter 16 in accordance with programs inputted in advance.

(8) In each of the foregoing embodiments, the base 2 may be formed separately along a central axis in the longitudinal direction (a tape guidance direction), and the attachment is interposed in a middle portion between separated sections. In addition, the operation arm 14, the joining roller 4, the rotary cutter 16, and the holding roller 18 may be modified as to have an adopted width of the attachment.

With to this configuration, setting of the apparatus may be modified in accordance with the width of the double-faced adhesive tape T.

### INDUSTRIAL UTILITY

As described above, this invention is suitable for joining a double-faced adhesive tape with a separator to a curved or bent workpiece.

1. A method of joining to a joining face of a workpiece a double-faced adhesive tape having one adhesive face exposed and the other adhesive face to which a separator is joined,
the double-faced adhesive tape being successively joined to a front face of the workpiece while slits are foamed at given intervals on sides of the separator joined to the supplied double-faced adhesive tape along a longitudinal tape direction.

2. The method of joining the double-faced adhesive tape according to claim 1, wherein
the slits are formed at given intervals at least on both sides of the separator of the double-faced adhesive tape and the separator along the longitudinal tape direction.

3. The method of joining the double-faced adhesive tape according to claim 2, wherein
the slits are alternately formed at given pitches on both sides of the double-faced adhesive tape.

4. The method of joining the double-faced adhesive tape according to claim 1, wherein
the slit has a V-shaped notch.

5. The method of joining the double-faced adhesive tape according to claim 1, wherein
formation of the slits is avoided on a linear joining course on the workpiece, and formation of the slits is performed on a curved joining course.

6. Double-faced adhesive tape joining apparatus for joining to a joining face of a workpiece a double-faced adhesive tape having one adhesive face exposed and the other adhesive face to which a separator is joined, comprising:
a tape guide device for guiding the double-faced adhesive tape to a joining position that is successively supplied to a base;
a joining section for pressing against the joining face of the workpiece the double-faced adhesive tape guided to the joining portion at a front end of the base; and
a tape cutting mechanism for forming slits on sides of the separator at given intervals along a longitudinal tape direction.

7. The double-faced adhesive tape joining apparatus according to claim 6, wherein
the tape cutting mechanism comprises:
an arm pivotally connected to the base and swingingly moving downward;
a rotary cutter provided at a lower portion of the arm for cutting the separator on the double-faced adhesive tape from an upper side; and
a holding roller holding the double-faced adhesive tape from the adhesive face thereof.

8. The double-faced adhesive tape joining apparatus according to claim 6, wherein
the tape cutting mechanism switches back and forth between an operating condition where the slits are formed and a non-operating condition where no slit is formed.

9. The double-faced adhesive tape joining apparatus according to claim 8, further comprising:
an elastic body for swingingly biasing the arm upward relative to the base.

10. The double-faced adhesive tape joining apparatus according to claim 9, further comprising:
a holding mechanism for fixedly holding the arm on the base such that the rotary cutter at the lower portion of the arm is fixed in an operation position when the arm moves downward against swinging bias.

11. The double-faced adhesive tape joining apparatus according to claim 6, wherein
the joining section is a roller supported on the front end of the base as to freely rotate.

12. The double-faced adhesive tape joining apparatus according to claim 6, wherein
the joining section is configured through formation of a tape joining groove at the planar front end of the base having a smaller thickness and a larger width than the double-faced adhesive tape.

13. The double-faced adhesive tape joining apparatus according to claim 6, wherein
the base is formed separately along a tape guidance direction, and an attachment is attachable in a middle portion between separated sections of the base.
